(19) United States
(12) Patent Application Publication
(10) Pub. No.: US 2019/0034875 A1
(43) Pub. Date: Jan. 31, 2019

(54) SYSTEM AND METHOD FOR NIL PICK HANDLING AT A WAREHOUSE

(71) Applicant: Walmart Apollo, LLC, Bentonville, AR (US)

(72) Inventors: Greg A. Bryan, Centerton, AR (US); Cristy C. Brooks, Cassville, MO (US); David B. Brightwell, Bella Vista, AR (US); Matthew A. Jones, Bentonville, AR (US); Benjamin D. Enssle, Bella Vista, AR (US); Jesse L. Eaton, Springdale, AR (US); Todd D. Mattingly, Bentonville, AR (US)

(21) Appl. No.: 16/031,647

(22) Filed: Jul. 10, 2018

Related U.S. Application Data
(60) Provisional application No. 62/538,880, filed on Jul. 31, 2017.

(51) Int. Cl. G06Q 10/08; G06K 9/00; B65G 1/137; G05D 1/00

(52) U.S. Cl. CPC G06Q 10/0875; G06Q 10/0835; G05D 2201/0216; B65G 1/1378; G05D 1/0088; G06K 9/00671

(57) ABSTRACT

Upon the occurrence of the nil pick, an amount of product that is available in the warehouse is determined as is a demand of the product from the replenishment settings. When the amount of product is sufficient to partially satisfy the demand, first instructions are transmitted to the warehouse instructing the warehouse to send selected amounts of the product to selected retail stores. When the amount of product is insufficient to satisfy any of the demand, a message is sent to a secondary supplier instructing the secondary supplier to ship products to the warehouse. Instructions are transmitted to the warehouse to perform a verification of an accuracy of the replenishment settings.

### CROSS-REFERENCE TO RELATED APPLICATION

This application claims the benefit of the following U.S. Provisional Application No. 62/538,880 filed Jul. 31, 2017, which is incorporated herein by reference in its entirety.

### TECHNICAL FIELD

These teachings relate generally to the handling of nil picks and, more specifically, to handling the occurrence of nil picks that occur in a warehouse or other type of distribution center

### BACKGROUND

Warehouses and other types of distribution centers hold products at a central location and distribute these products as orders from customers are received. For example, various retail stores send orders to the warehouse or distribution center to obtain products that the retail store desires to stock and sell. Once the products are transported from the warehouse to the retail store, the products can be purchased by the public.

When an order is received at the warehouse, ideally the requested products are located and sent to the requesting customer. However, “nil picks” sometimes arise when there is no product available, or when there is insufficient product to meet the demand.

Nil picks at the warehouse cause various types of problems at the retail store. For example, when a retail store cannot obtain product and that product is not available on the shelves of the retail store, customers may seek the same product at other retail stores. This leads to lost sales for the retail store. The customer may also seek a substitute product, which leads to lost sales for the missing product. Nil picks additionally lead to customer frustration with the retail store, as the customer cannot find a desired product. The customer must either do without the product, find the product at another store, or find a substitute product. None of these options are necessarily attractive to many customers.

### BRIEF DESCRIPTION OF THE DRAWINGS

The above needs are at least partially met through provision of approaches that take actions relating to nil picks at warehouse and distribution centers particularly when studied in conjunction with the drawings, wherein:

FIG. 1 comprises a diagram of a system as configured in accordance with various embodiments of these teachings;

FIG. 2 comprises a flowchart as configured in accordance with various embodiments of these teachings;

FIG. 3 comprises a flowchart as configured in accordance with various embodiments of these teachings;

FIG. 4 comprises a flowchart as configured in accordance with various embodiments of these teachings;

FIG. 5 comprises a flowchart as configured in accordance with various embodiments of these teachings;

FIG. 6 comprises a flowchart as configured in accordance with various embodiments of these teachings;

FIG. 7 comprises a diagram as configured in accordance with various embodiments of these teachings.

### DETAILED DESCRIPTION

Generally speaking, systems and methods are provided that upon the occurrence of a nil pick at a warehouse or distribution center, allocate any products available amongst requesting customers (e.g., retail stores), or order products from secondary sources when no products are available. Additionally, parameters related to or controlling the re-ordering of products are analyzed and changed in order to eliminate (or reduce the number of) future nil picks.

In many of these embodiments, a product inventory control system is configured to manage nil picks in a warehouse. The system includes a transceiver, a network, an interface, a database, and a control circuit.

The transceiver is disposed at a warehouse and is configured to receive an electronic indication of a nil pick made at the warehouse. The nil pick occurs when one or more orders are received for a product and when an insufficient amount of the product exists at the warehouse to satisfy the one or more orders.

The network is coupled to the transceiver. The interface is disposed at a central processing center. The interface is coupled to the network and configured to receive the electronic indication of the nil pick from the network. The interface is configured to receive reports from retail stores from the network, and the reports indicate a demand for the product.

The database is disposed at the central processing center, and is configured to store replenishment settings. The replenishment settings are associated with one or more of: the demand for the product indicated in the reports, a lead time to obtain the product from a supplier, or a safety stock amount that indicates an amount of the product available for shipment when a supplier is late or fails to deliver the product.

The control circuit is disposed at the central processing center and is coupled to the interface and the database. The control circuit is configured to, upon the occurrence of the nil pick determine an amount of product that is available in the warehouse, and obtain the demand of the product from the replenishment settings. When the amount of product is sufficient to partially satisfy the demand, the control circuit is configured to transmit first instructions to the warehouse instructing the warehouse to send selected amounts of the product to selected retail stores. When the amount of product is insufficient to satisfy any of the demand, the control circuit is configured to transmit a message to a secondary supplier via the interface and network instructing the secondary supplier to ship products to the warehouse. The control circuit is still further configured to transmit second instructions to the warehouse to perform a verification of an accuracy of the replenishment settings, and when verification indicates that at least one of the replenishment settings are inaccurate, take an action that is effective to minimize future nil picks.

The action may determining an availability of a substitute product, determining an identity of a substitute supplier, or adjusting the replenishment settings based upon results of the verification. Other examples of actions are possible.

In aspects, the first instructions instruct the warehouse to prioritize and assign available product amongst a plurality of retail stores.

In examples, the amount of product available at the warehouse is determined by instructing automated vehicles with sensors to verify the amount of product available. In other examples, the amount of product available at the warehouse is determined by instructing employees of the warehouse to verify the amount of product available.

In yet other examples, a supplier is punished when an order fill rate for the product is not acceptable. In some other examples, the insufficient amount of the product is a non-zero number. In still further examples, the insufficient amount of the product is exactly zero.

In others of these embodiments, at a central processing center, an electronic indication of a nil pick made at the warehouse is received. The nil pick occurs when one or more orders are received for a product and when an insufficient amount of the product exists at the warehouse to satisfy the one or more orders. At the central processing center, reports are received from retail stores, and the reports indicate a demand for the product.

A database at the central processing center is configured to store replenishment settings. The replenishment settings are associated with one or more of: the demand for the product indicated in the reports, a lead time to obtain the product from a supplier, or a safety stock amount that indicates an amount of the product available for shipment when a supplier is late or fails to deliver the product.

Upon the occurrence of the nil pick, an amount of product that is available in the warehouse is determined as is a demand of the product from the replenishment settings. When the amount of product is sufficient to partially satisfy the demand, first instructions are transmitted to the warehouse instructing the warehouse to send selected amounts of the product to selected retail stores. When the amount of product is insufficient to satisfy any of the demand, a message is sent to a secondary supplier instructing the secondary supplier to ship products to the warehouse. Second instructions are transmitted to the warehouse to perform a verification of an accuracy of the replenishment settings, and when verification indicates that at least one of the replenishment settings are inaccurate, an action is taken that is effective to minimize future nil picks.

In others of these embodiments, a product inventory control system is configured to manage nil picks in a warehouse. The system includes a warehouse, a first automated vehicle, a second automated vehicle, first, second, and third sensors, an electronic communication network, a plurality of retail stores, a plurality of sales entry devices, a transceiver circuit, an electronic interface, a database, and a control circuit.

The warehouse is configured to store products. The first automated vehicle includes the first sensor. The first automated vehicle is also disposed in the warehouse.

The second automated vehicle is disposed in the warehouse and includes the second sensor. The third sensor is disposed at the warehouse.

The plurality of retail stores obtain the products from the warehouse. The plurality of sales entry devices are disposed in the retail stores. The sales entry devices are configured to obtain sales information indicating demand for the products. The demand for the products is included in one or more electronic reports created at the stores and transmitted on the network.

The transceiver circuit is coupled to the network and the first automated vehicle. The transceiver circuit is disposed at the warehouse and configured to receive an electronic indication of a nil pick made at the warehouse from the first automated vehicle. The nil pick occurs when one or more electronic orders from the stores are received for one of the products and when the first sensor of the first automated vehicle obtains information indicating a product requested in the orders is insufficient to satisfy the orders. The transceiver circuit is configured to transmit the indication of the nil pick over the network.

The electronic interface is disposed at a central processing center. The interface is coupled to the network and configured to receive the electronic indication of the nil pick from the network. The interface is configured to receive the electronic reports from retail stores from the network.

The database is disposed at the central processing center. The database is configured to store replenishment settings. The replenishment settings are associated with one or more of: (a) the demand for the product indicated in the electronic reports, (b) a lead time to obtain the product from a supplier, and (c) a safety stock amount that indicates an amount of the product available for shipment when a supplier is late or fails to deliver the product.

The control circuit is disposed at the central processing center and is coupled to the interface and the database. The control circuit is configured to, upon the occurrence of the nil pick: determine an amount of product that is available in the warehouse; obtain the demand of the product from the replenishment settings; when the amount of product is sufficient to partially satisfy the demand, transmit first instructions to the warehouse instructing the warehouse to send selected amounts of the product to selected retail stores; when the amount of product is insufficient to satisfy any of the demand, transmit a message to a secondary supplier via the interface and network instructing the secondary supplier to ship products to the warehouse; transmit second instructions to the warehouse or the retail stores via the network to perform a verification of an accuracy of the replenishment settings, the verification using information obtained from the third sensor, and when verification indicates that at least one of the replenishment settings are inaccurate, taking an action that is effective to minimize future nil picks; transmit third instructions to the second automated vehicle, the third instructions causing the second automated vehicle to search the warehouse for the product and when the second automated vehicle locates the product, the second automated vehicle moves at least some of the product to a shipment area of the warehouse to at least partially fulfill the order.

In aspects, the action may be determining an availability of a substitute product, determining an identity of a substitute supplier, and adjusting the replenishment settings based upon results of the verification. Other examples of actions are possible.

In other aspects, the first instructions instruct the warehouse to prioritize and assign available product amongst a plurality of retail stores.

In examples, the amount of product available at the warehouse is determined by instructing the second automated vehicle to utilize the second sensor to verify the amount of product available. In other examples, the amount of product available at the warehouse is determined by instructing employees of the warehouse to verify the amount of product available.

In other aspects, a supplier is punished when an order fill rate for the product is not acceptable.

In other examples, the insufficient amount of the product is a non-zero number. In still other examples, the insufficient amount of the product is exactly zero.

In still other aspects, one or all of the first sensor, the second sensor, the third sensor are cameras. Other examples of sensors are possible.

In yet others of these embodiments, nil picks occurring at a warehouse are managed. A first automated vehicle is deployed in a warehouse, and the first automated vehicle includes a first sensor. A second automated vehicle is deployed in the warehouse, and the second automated vehicle includes a second sensor. A third sensor is also disposed at the warehouse.

A plurality of sales entry devices are disposed in the retail stores. The sales entry devices are configured to obtain sales information indicating demand for products in the warehouse. The demand for the products is included in one or more electronic reports created at the stores and transmitted on a network.

At a central processing center, an electronic indication of a nil pick made at the warehouse via the network is received. The nil pick occurs when one or more orders are received for a product and when the first sensor of the first automated vehicle obtains information indicating a product requested in the orders is insufficient to satisfy the orders.

At the central processing center, reports from retail stores are received. The reports indicate a demand for the product.

A database at the central processing center is configured to store replenishment settings. The replenishment settings are associated with one or more of: (a) the demand for the product indicated in the reports, (b) a lead time to obtain the product from a supplier, and (c) a safety stock amount that indicates an amount of the product available for shipment when a supplier is late or fails to deliver the product.

Upon the occurrence of the nil pick: an amount of product that is available in the warehouse is determined; a demand of the product is determined from the replenishment settings; when the amount of product is sufficient to partially satisfy the demand, first instructions are transmitted to the warehouse instructing the warehouse to send selected amounts of the product to selected retail stores; when the amount of product is insufficient to satisfy any of the demand, a message is transmitted to a secondary supplier instructing the secondary supplier to ship products to the warehouse; second instructions are transmitted to the warehouse or the retail stores to perform a verification of an accuracy of the replenishment settings, the verification using information obtained from the third sensor, and when verification indicates that at least one of the replenishment settings are inaccurate, an action is taken that is effective to minimize future nil picks; and third instructions are transmitted to the second automated vehicle, the third instructions causing the second automated vehicle to search the warehouse for the product and when the second automated vehicle locates the product, the second automated vehicle moves at least some of the product to a shipment area of the warehouse to at least partially fulfill the order.

It will be appreciated that although the examples described herein involve warehouses and distribution centers, the principals described herein can be applied to any distribution-type element (e.g., a mechanical element) or system. For example, a central hub or center may store oil (e.g., brought in by pipelines), and distribute oil that is received and stored to different customers. Other examples are possible.

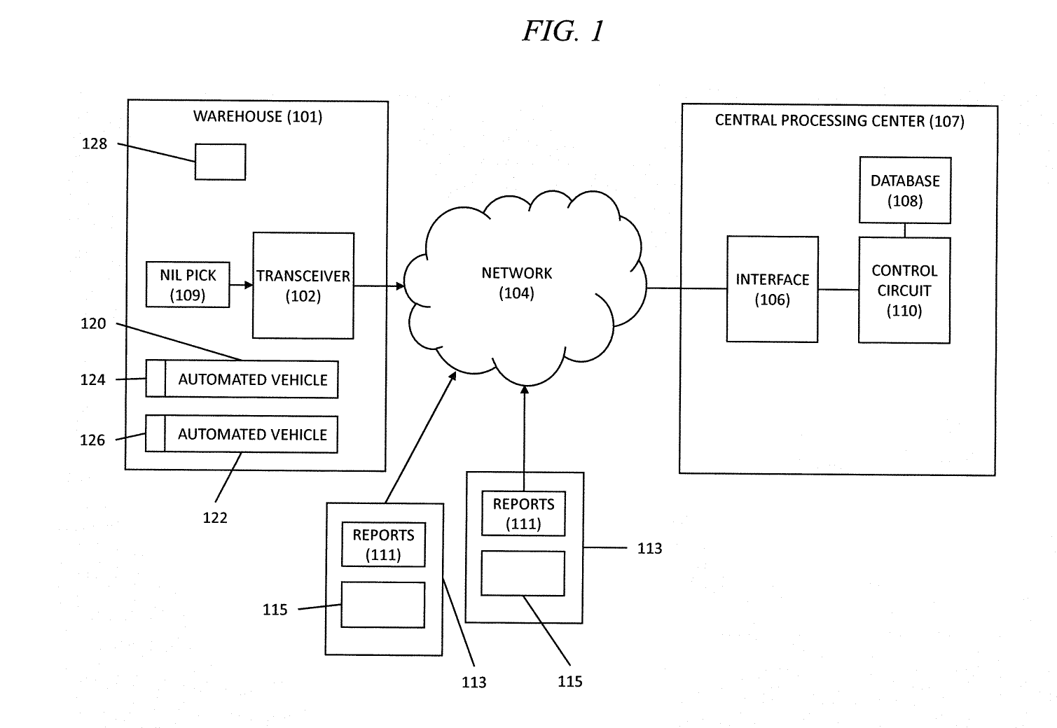

Referring now to FIG. 1, one example of a system 100 for handling nil picks 109 is described. The system 100 includes a transceiver 102 (disposed at a warehouse 101), and a network 104. An interface 106, a database 108, and a control circuit 110 are disposed at a central processing center 107 and coupled to the network 104.

The warehouse 101 is any type of central storage location or distribution center. Generally speaking, the public does not have direct access to and cannot directly purchase products from the warehouse 101. The central processing center 107, in examples, may be any type of central processing center (e.g., a home office) and may include user interfaces.

The transceiver 102 is disposed at a warehouse 101 and is configured to receive an electronic indication of a nil pick made at the warehouse 101. The transceiver 102 can be configured as any combination of computer software and hardware. In aspects, the transceiver 102 is a transceiver circuit.

The network 104 may be any type of network. The network 104 may include elements such as processors, routers, and gateways. The network 104 may be combinations of different types of networks. In one example, the network 104 is the internet or the cloud.

The interface 106 transmits and receives electronic communications to and from the network 104. The interface 106 can be configured as any combination of computer software and hardware.

The database 108 is disposed at the central processing center 107, and is configured to store replenishment settings. In aspects, the replenishment settings are associated with one or more of: the demand for the product indicated in the reports, a lead time to obtain the product from a supplier, or a safety stock amount that indicates an amount of the product available for shipment when a supplier is late or fails to deliver the product. The replenishment settings may be stored in any type of data structure such as a table or a linked list. Other examples of replenishment settings and data structures are possible.

The control circuit 110 is disposed at the central processing center 107 and is coupled to the interface 106 and the database 108. It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 110 may be configured (for example, by using corresponding programming stored in a memory as will be well understood by those skilled in the art) to carry out one or more of the steps, actions, and/or functions described herein.

In examples, the nil pick 109 (or indication of the nil pick) occurs when one or more orders are received for a product and when an insufficient amount of the product exists at the warehouse to satisfy the one or more orders. The nil pick 109 may be communicated electronically to the transceiver 102. For example, the nil pick 109 may originate in or from an inventory computer program the detects when a request for a product is made and there is not enough product (or zero product) available. In other examples, an employee of the warehouse enters the nil pick 109 into a portable electronic device. In other examples and as described elsewhere herein, an automated vehicle such as an automated ground vehicle or aerial drone may make the nil pick.

The interface 106 is configured to receive reports 111 from retail stores 113 from the network 104, and the reports 111 indicate a demand for the product (e.g., how much of the product is sold over a given amount of time). In examples, the reports 111 are electronic reports. The demand may be indicated in a variety of different ways include, in aspects, the amount of product sold over a particular time period. The interface 106 also receives the nil pick 109.

The retail stores 113 are any type of retail stores that offer products to the public. The retail stores 113 order and receive products from the warehouse 101. Although shown as originating from retail stores 113 in FIG. 1, it will be understood that the reports 111 may come from other sources as well.

The retail stores 113 also include sales entry devices 115. The sales entry devices 115 may be any type of electronic sales entry device (e.g., cash register with or without a scanner) in which sales transactions are entered. Information from the sales entry devices 115 may be obtained (e.g., information indicating the demand for a product) and included in the reports 111. The reports 111 may be created automatically or manually at the retail stores 113. In other examples the sales report information may be send to the central processing center 107, where demand can be determined.

A first automated vehicle 120 includes a first sensor 124 and is disposed in the warehouse 101. A second automated vehicle 122 is also disposed in the warehouse 101 and includes a second sensor 126. A third sensor 128 is also disposed at the warehouse 101. Other sensors may be deployed at various locations.

In examples, the first automated vehicle 120 and the second automated vehicle 122 may be automated ground vehicles or aerial drones. The sensors 124, 126, and 128 may be cameras, scanners, motion detectors, temperature sensors, or pressure sensors to mention a few examples. In some examples, the first automated vehicle 120 and the second automated vehicle 122 are the same vehicle. In other examples, the first automated vehicle 120 and the second automated vehicle 122 are different vehicles.

In aspects, the transceiver circuit 102 is coupled to the network 104 and to the first automated vehicle 120. For example, a wireless coupling may be used. In some examples, the transceiver circuit 102 is configured to receive an electronic indication of a nil pick made at the warehouse 101 from the first automated vehicle 120. The nil pick occurs when one or more electronic orders from the stores 113 are received for one of the products and when the first sensor 124 of the first automated vehicle 120 obtains information indicating a product requested in the orders 111 is insufficient to satisfy the orders. The transceiver circuit 102 is configured to transmit the indication of the nil pick 109 over the network 104. For instance, the first sensor 124 may be a camera and this camera may fail to find the product in the warehouse 101.

The control circuit 110 configured to, upon the occurrence of the nil pick 109 determine an amount of product that is available in the warehouse 101. The control circuit 110 is configured to obtain the demand of the product from the replenishment settings. When the amount of product is sufficient to partially satisfy the demand, the control circuit 110 is configured to transmit first instructions to the warehouse 101 instructing the warehouse 101 to send selected amounts of the product to selected retail stores. When the amount of product is insufficient to satisfy any of the demand, the control circuit 110 is configured to transmit a message to a secondary supplier via the interface 106 and network 104 instructing the secondary supplier to ship products to the warehouse 101.

The control circuit 110 is configured to transmit second instructions to the warehouse 101 to perform a verification of an accuracy of the replenishment settings, and when verification indicates that at least one of the replenishment settings are inaccurate, to take an action that is effective to minimize future nil picks. The action may include determining an availability of a substitute product, determining an identity of a substitute supplier, or adjusting the replenishment settings based upon results of the verification. Other examples of actions are possible.

In aspects, the third sensor 128 may be used to verify some of the settings. For example, the third sensor 128 may be a camera that can be used to verify an amount of safety stock in the warehouse 101. In yet other aspects, other sensors can be deployed at the retail stores 113 and these can be used to verify the accuracy of reported product demand at the stores 113. For instance, these sensors can record sales transactions and a comparison can be made between the recorded transactions and the reported demand. In other examples, a manual comparison can be made.

In aspects, the first instructions instruct the warehouse 101 to prioritize and assign available product amongst a plurality of retail stores 113.

In other examples, the amount of product available at the warehouse 101 is determined by instructing automated vehicles with sensors to verify the amount of product available. For instance, the amount of product available at the warehouse is determined by instructing the second automated vehicle 122 to utilize the second sensor 126 (e.g., a camera or product ID scanner) to verify the amount of product available. In other examples, the amount of product available at the warehouse is determined by instructing employees of the warehouse 101 to verify the amount of product available.

The control circuit 110 also transmits may third instructions to the second automated vehicle 122. The third instructions cause the second automated vehicle 122 to search the warehouse 101 for the product and when the second automated vehicle 122 locates the product, the second automated vehicle 122 moves at least some of the product to a shipment area of the warehouse 101 to at least partially fulfill the order. In aspects, the approaches herein can be used to determine where to ship the amount found by the automated vehicle 122 (e.g., to the largest stores or to the most important stores). In examples, the product may be transitioning through the store and, consequently, the reported nil pick may not be accurate since the product is actually present in the warehouse 101. Consequently, sending the automated vehicle to search for a product that is seemingly missing helps to nullify the effects of making the nil pick.

In still other examples, a supplier is punished when an order fill rate for the product is not acceptable. In some other examples, the insufficient amount of the product is a non-zero number. In yet other examples, the insufficient amount of the product is exactly zero.

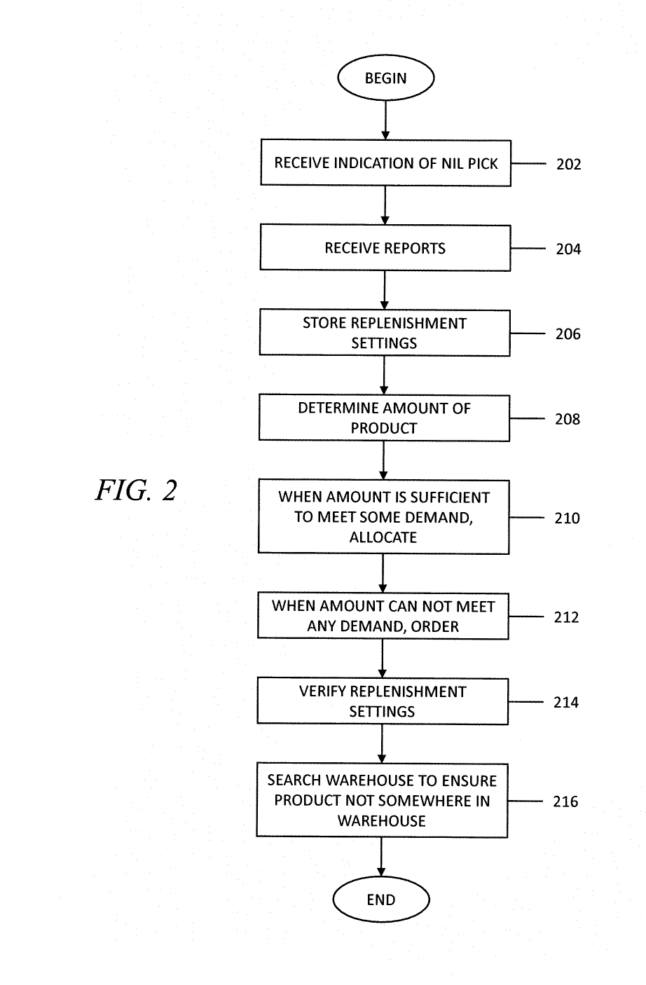

Referring now to FIG. 2, one example of an approach for handling nil picks at a warehouse or distribution center is described. At step 202 and at a central processing center, an electronic indication of a nil pick made at the warehouse is received. The nil pick occurs when one or more orders are received for a product and when an insufficient amount of the product exists at the warehouse to satisfy the one or more orders. The electronic indication may be in any form, format, or according to any protocol. The nil pick may be made by an automated vehicle that includes sensors.

At step 204 and at the central processing center, reports are received from retail stores, and the reports indicate a demand for the product. The reports may be in any format or form. For example, electronic reports indicating the amount of sales over a given amount of time may be reported.

At step 206, a database at the central processing center is configured to store replenishment settings. In aspects, the replenishment settings are associated with one or more of the demand for the product indicated in the reports, the lead time to obtain the product from a supplier, or the safety stock amount that indicates an amount of the product available for shipment when a supplier is late or fails to deliver the product. Other examples of replenishment settings are possible.

At step 208 and upon the occurrence of the nil pick, an amount of product that is available in the warehouse is determined as is a demand of the product from the replenishment settings. The amount of product available in the warehouse may be determined, for example, by consulting an electronic inventory value that is stored in the database. For example, a perpetual inventory (PI) value may be consulted. The demand may be received from reports from retail store, for example, indicating the amount of product sold over a particular time period.

At step 210 and when the amount of product is sufficient to partially satisfy the demand, first instructions are transmitted to the warehouse instructing the warehouse to send selected amounts of the product to selected retail stores. In examples, amount of product is sufficient to partially satisfy demand when at least some product is available. For example, when the demand for a product is 10 units, and 5 units of product are available, then there is an amount of product available that can partially satisfy the demand. The demand may be measured from one customer, more than one customer, or across all customers. The first instructions may be in any form, format, or according to any protocol.

At step 212 and when the amount of product is insufficient to satisfy any of the demand, a message is sent to a secondary supplier instructing the secondary supplier to ship products to the warehouse. In aspects, amount of product is insufficient to satisfy demand when no product is available. The secondary supplier may be any type of organization and may be another warehouse or distribution center. The message may be in any form, format, or according to any protocol.

At step 214 and upon the occurrence of the nil pick, second instructions are transmitted to the warehouse to perform a verification of an accuracy of the replenishment settings, and when verification indicates that at least one of the replenishment settings are inaccurate, an action is taken that is effective to minimize future nil picks. Verification may be made with automated vehicles and or sensors. The second instructions may be in any form, format, or according to any protocol.

At step 216 and upon the occurrence of the nil pick, third instructions are transmitted to an automated vehicle in the warehouse. The third instructions cause the automated vehicle to search the warehouse for the product and when the automated vehicle locates the product, the automated vehicle moves at least some of the product to a shipment area of the warehouse to at least partially fulfill the order. In examples, the product may be transitioning through the store and, consequently, the reported nil pick may not be accurate since the product is actually present in the warehouse.

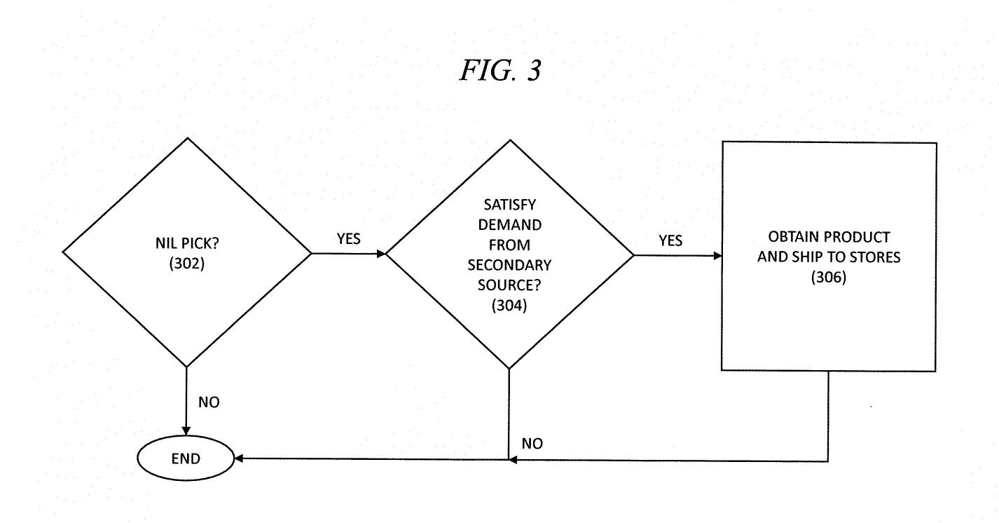

Referring now to FIG. 3, one example of an approach for handling a situation when no demand can be fulfilled is described. In this example, a warehouse or other type of distribution center receives orders from customers such as retail stores.

At step 302, it is determined if there was a nil pick. A nil pick in this case means that there is no product left to satisfy demand. For example, an order may be received and the inventory is accessed and shows that there is no product (zero amount of a particular product) in the warehouse.

At step 304, it is determined if the demand can be satisfied by sourcing the product from secondary sources. If the answer is negative, execution ends. If the answer is affirmative, then execution continues at step 306.

At step 306, the product is obtained and shipped to the customer. The secondary source may ship directly to the customer. In other examples, the secondary supplier ships the product to the warehouse or retail store.

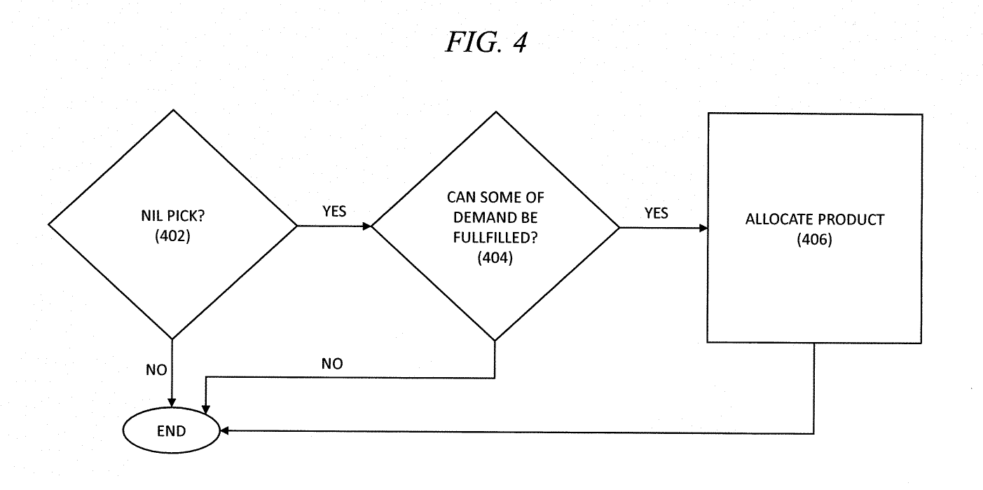

Referring now to FIG. 4, one example of an approach for satisfying partial demand is described. In this example, a warehouse or other type of distribution center receives orders from customers such as retail stores.

At step 402, it is determined whether a nil pick has occurred. Multiple product orders requesting the product may be received from multiple customers. In this example, a nil pick occurs where some of the demand can be fulfilled.

At step 404, it is determined if there is enough product so that the demand can be partially satisfied. If the answer is negative, then execution ends. If the answer is affirmative, execution continues at step 406.

At step 406, product allocation is made. In one example, available product is sent to stores with the most demand. In other examples, product is sent to the stores that have the highest rating.

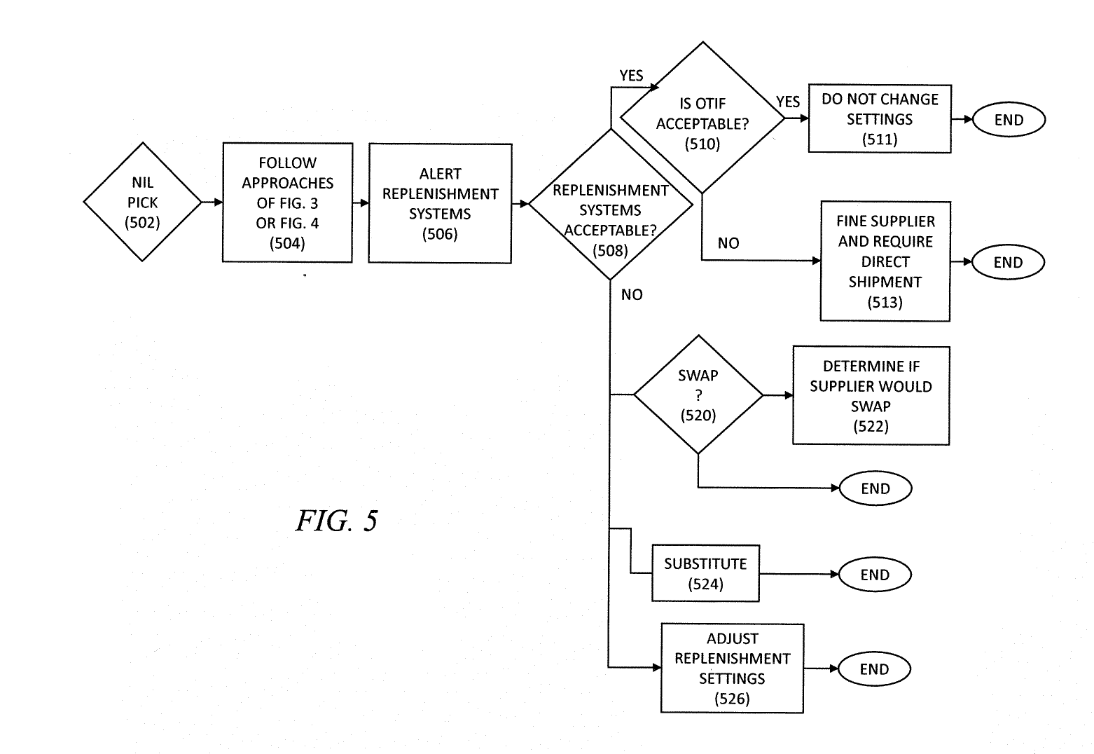

Referring now to FIG. 5, an example of an approach for preventing future nil picks is described. At step 502, it is determined that a nil pick has occurred. A nil pick in this case means that there is no product left to satisfy demand. For example, an order may be received and the inventory is accessed and shows that there is no product in the warehouse. In addition, a nil pick occurs when there is some product available.

At step 504, depending upon the type of nil pick, the approaches shown in either FIG. 3 or FIG. 4 are executed. That is, the approach of FIG. 3 is executed when there is no product to supply demand. The approach of FIG. 4 is executed when there is product that at least partially satisfies demand.

At step 506, replenishment systems are alerted of the nil-picked item. For example, an alert may be sent to a central processing center (home office) and the forecasting mechanism (e.g., implemented as computer software) at the central processing center.

At step 508, it is determined if the replenishment settings are acceptable. In aspects, the replenishment settings are associated with the demand for the product indicated in the reports, the lead time to obtain the product from a supplier, and/or the safety stock amount that indicates an amount of the product available for shipment when a supplier is late or fails to deliver the product.

The verification of the acceptability of the replenishment settings may be accomplished by manual, automatic, or some combination of manual or automatic approaches. For example, a store employee may perform various tasks to verify the accuracy of the settings. In other examples, cameras or automated vehicles may be used to perform verifications. For example, cameras may obtain images and these images analyzed to verify the accuracy of the settings. Other examples are possible.

At step 510 and if the settings are acceptable, a determination is made as to whether an on-time in full (OTIF) metric is acceptable. The OTIF metric relates to how many deliveries are supplied on time without any article missing. If the OTIF is acceptable, then no change to the settings is made (step 511). If the OTIF is not acceptable, at step 513, the supplier is fined and required to direct shipment the product to the customer or to the store. If the OTIF is not acceptable, it can be inferred that the supplier is not performing their functions and responsibilities adequately.

If the answer at step 506 is negative (the replenishment settings are not acceptable), then one or more steps may be executed (steps 520, 522, 524 and/or 526).

At step 520, a determination is made as to whether the customer wants to swap another product for the missing product. If the answer is affirmative, at step 522, a determination is made as to whether the supplier would perform a swap from the missing item to another item.

In another alternative, at step 524 a substitution of one item for the missing item occurs. In this case, a determination is made that the replacement item is acceptable. In examples, the replacement item is sent to the customer.

In yet another alternative, at step 526, the replenishment settings are adjusted. In one example, the demand settings are changed. The settings may be changed based upon direct user input, or an automatic calculation may be performed to supply a new replenishment setting.

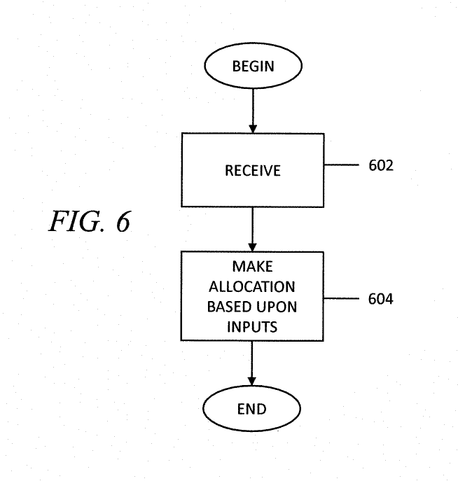

Referring now to FIG. 6, one example of an approach for selecting the amount of product to be sent to different retail stores is described. The approach of FIG. 6 is executed when the amount of product is sufficient to partially satisfy the demand and the amount of product sent to selected retail stores needs to be determined.

At step 602, evaluative inputs are received. These inputs are utilized to determine the amount of product to be sent to each retail store. For example, store performance data may be received. This may, in examples, show store profitability, or how well a store adheres to various policies. In other examples, the inputs received include store size or store location.

At step 604, a product allocation is made based upon the received inputs. There are various approaches that can be used to make the product allocation. In one example, the largest stores receive products until the supply is exhausted. For instance, if three stores each need four products each, and there are five products available, then the largest store will receive four products, the next largest store will receive one product, and the last store will receive zero products.

In other example, allocation is made based upon the proportion of demand at a given store. For example, a first store may need four products, and a second store may need two products. Three products may be available. In this case, the first store may receive two of the products and the second store may receive one of the products.

In another example, a weight is assigned to each input factor and a weighted score is obtained and assigned to each store. Each store receives an allocation of products in proportion to the weighted score. In aspects, weights may be assigned to the different inputs (e.g., the size of the store may be of greatest importance as compared to store performance). The weights may be multiplied with the actual input, and the resultant products summed to produce the weighted score. An amount of product may be assigned to a particular retail store based upon the weighted score (e.g., a weighted score of “2” for a first store allows the first store to receive twice as much product as another store that received a weighted score of “1”).

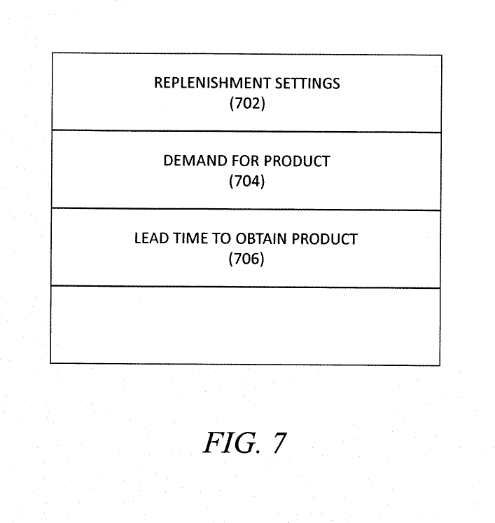

Referring now to FIG. 7, one example of memory structure 700 of replenishment settings is described. The structure 700 is organized as a table and includes a demand field 702 and a lead time field 704. The structure 700 may be stored at a database in a central processing center.

The demand field 702 describes the demand for a product. This field may represent the number of units of a product that are sold at a particular retail store over a particular length of time. This information may be obtained from data that comes from electronic sales entry devices that record sales transaction.

The lead time field 704 may represent the amount of time reported by the store to acquire a product from a supplier.

It will be appreciated that the data structure of FIG. 7 is one example, and that other examples of data structures including different content are possible.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A product inventory control system that is configured to manage nil picks in a warehouse, the system comprising:
a warehouse that is configured to store products;
a first automated vehicle including a first sensor, the first automated vehicle disposed in the warehouse;
a second automated vehicle disposed in the warehouse, the second automated vehicle including a second sensor;
a third sensor disposed at the warehouse;
an electronic communication network;
a plurality of retail stores that obtain the products from the warehouse;
a plurality of sales entry devices disposed in the retail stores, the sales entry devices being configured to obtain sales information indicating demand for the products, the demand for the products being included in one or more electronic reports created at the stores and transmitted on the network;
a transceiver circuit coupled to the network and the first automated vehicle, the transceiver circuit being disposed at a warehouse and configured to receive an electronic indication of a nil pick made at the warehouse from the first automated vehicle, the nil pick occurring when one or more electronic orders from the stores are received for one of the products and when the first sensor of the first automated vehicle obtains information indicating a product requested in the orders is insufficient to satisfy the orders, the transceiver circuit configured to transmit the indication of the nil pick over the network;
an electronic interface disposed at a central processing center, the interface being coupled to the network and configured to receive the electronic indication of the nil pick from the network, the interface being configured to receive the electronic reports from retail stores from the network;
a database disposed at the central processing center, the database being configured to store replenishment settings, the replenishment settings being associated with one or more of: (a) the demand for the product indicated in the electronic reports, (b) a lead time to obtain the product from a supplier, and (c) a safety stock amount that indicates an amount of the product available for shipment when a supplier is late or fails to deliver the product;
a control circuit disposed at the central processing center and coupled to the interface and the database, the control circuit configured to, upon the occurrence of the nil pick:
determine an amount of product that is available in the warehouse;
obtain the demand of the product from the replenishment settings;
when the amount of product is sufficient to partially satisfy the demand, transmit first instructions to the warehouse instructing the warehouse to send selected amounts of the product to selected retail stores;
when the amount of product is insufficient to satisfy any of the demand, transmit a message to a secondary supplier via the interface and network instructing the secondary supplier to ship products to the warehouse;
transmit second instructions to the warehouse or the retail stores via the network to perform a verification of an accuracy of the replenishment settings, the verification using information obtained from the third sensor, and when verification indicates that at least one of the replenishment settings are inaccurate, taking an action that is effective to minimize future nil picks;
transmit third instructions to the second automated vehicle, the third instructions causing the second automated vehicle to search the warehouse for the product and when the second automated vehicle locates the product, the second automated vehicle moves at least some of the product to a shipment area of the warehouse to at least partially fulfill the order.

2. The system of claim 1, wherein the action is selected from the group consisting of: determining an availability of a substitute product, determining an identity of a substitute supplier, and adjusting the replenishment settings based upon results of the verification.

3. The system of claim 1, wherein the first instructions instruct the warehouse to prioritize and assign available product amongst a plurality of retail stores.

4. The system of claim 1, wherein the amount of product available at the warehouse is determined by instructing the second automated vehicle to utilize the second sensor to verify the amount of product available.

5. The system of claim 1, wherein the amount of product available at the warehouse is determined by instructing employees of the warehouse to verify the amount of product available.

6. The system of claim 1, wherein a supplier is punished when an order fill rate for the product is not acceptable.

7. The system of claim 1, wherein the insufficient amount of the product is a non-zero number.

8. The system of claim 1, wherein the insufficient amount of the product is exactly zero.

9. The system of claim 1, wherein one or all of the first sensor, the second sensor, the third sensor are cameras.

10. A method for managing nil picks occurring at a warehouse, the method comprising:
deploying a first automated vehicle in a warehouse, the first automated vehicle including a first sensor;
deploying a second automated vehicle in the warehouse, the second automated vehicle including a second sensor;
deploying a third sensor disposed at the warehouse;
deploying a plurality of sales entry devices disposed in the retail stores, the sales entry devices being configured to obtain sales information indicating demand for products in the warehouse, the demand for the products being included in one or more electronic reports created at the stores and transmitted on a network;
at a central processing center, receiving an electronic indication of a nil pick made at the warehouse via the network, the nil pick occurring when one or more orders are received for a product and when the first sensor of the first automated vehicle obtains information indicating a product requested in the orders is insufficient to satisfy the orders;
at the central processing center, receiving reports from retail stores, the reports indicating a demand for the product;
configuring a database to store replenishment settings, the database being disposed at the central processing center, the replenishment settings being associated with one or more of: (a) the demand for the product indicated in the reports, (b) a lead time to obtain the product from a supplier, and (c) a safety stock amount that indicates an amount of the product available for shipment when a supplier is late or fails to deliver the product;
upon the occurrence of the nil pick:
determining an amount of product that is available in the warehouse and determining a demand of the product from the replenishment settings;
when the amount of product is sufficient to partially satisfy the demand, transmitting first instructions to the warehouse instructing the warehouse to send selected amounts of the product to selected retail stores;
when the amount of product is insufficient to satisfy any of the demand, transmitting a message to a secondary supplier instructing the secondary supplier to ship products to the warehouse;
transmitting second instructions to the warehouse or the retail stores to perform a verification of an accuracy of the replenishment settings, the verification using information obtained from the third sensor, and when verification indicates that at least one of the replenishment settings are inaccurate, taking an action that is effective to minimize future nil picks,
transmitting third instructions to the second automated vehicle, the third instructions causing the second automated vehicle to search the warehouse for the product and when the second automated vehicle locates the product, the second automated vehicle moves at least some of the product to a shipment area of the warehouse to at least partially fulfill the order.

11. The method of claim 10, wherein the action is selected from the group consisting of: determining an availability of a substitute product, determining an identity of a substitute supplier, and adjusting the replenishment settings based upon results of the verification.

12. The method of claim 10, wherein the first instructions instruct the warehouse to prioritize and assign available product amongst a plurality of retail stores.

13. The method of claim 10, wherein the amount of product available at the warehouse is determined by instructing the second automated vehicle to utilize the second sensor to verify the amount of product available.

14. The method of claim 10, wherein the amount of product available at the warehouse is determined by instructing employees of the warehouse to verify the amount of product available.

15. The method of claim 10, further comprising punishing a supplier when an order fill rate for the product is not acceptable.

16. The method of claim 10, wherein the insufficient amount of the product is a non-zero number.

17. The method of claim 10, wherein the insufficient amount of the product is exactly zero.

18. The method of claim 10, wherein one or all of the first sensor, the second sensor, the third sensor are cameras.
